(19) United States
(12) Patent Application Publication
(10) Pub. No.: US 2010/0239317 A1
(43) Pub. Date: Sep. 23, 2010

(54) IMAGE FORMING UNIT AND IMAGE FORMING APPARATUS

(75) Inventor: Mikio MOTOMURA, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/724,794

(22) Filed: Mar. 16, 2010

(30) Foreign Application Priority Data
Mar. 17, 2009 (JP) 2009-065264

(51) Int. Cl. G03G 15/00; G03G 21/00

(52) U.S. Cl. 399/159; 399/350

(57) ABSTRACT

A durability with respect to a film wear and defect of a photosensitive layer on the photosensitive body is improved, and thinning the photosensitive layer is planned. An image forming unit that comprises a photosensitive body; a charge means that charges surface of the photosensitive body; a development means that develops an electrostatic latent image formed on the surface of the photosensitive body with the developer through shining an exposure light to form a developer image on the surface of the photosensitive body; and a cleaning means that removes remaining developer on the surface of the photosensitive body by pressing against the surface of the photosensitive body. On the top surface layer of the photosensitive body, Martens hardness value is 175˜196N/mm²; elastic deformation rate is 35˜48%; and static friction coefficient is under 0.535.

### FIELD OF THE INVENTION

The invention relates to an image forming unit and an image forming apparatus that use an electrophotography process.

### BACKGROUND OF THE INVENTION

In the recent years, in the image forming apparatus that forms an image through an electrophotography process such as a printer, a copying machine, a facsimile apparatus and the like, adding to a high quality of picture (high resolution) and a high speed, a high durability of a process cartridge of an expendable article becomes to be needed. Especially, in the image forming apparatus that adopts a contact electrification method that charges drum surface by contacting a charge roller with the surface of the photosensitive drum, a contact development method with a mono-component non-magnetism toner, a cleaning method of the remaining toner with a cleaning blade and the like to the electrophotography process, a film wear and defect of the photosensitive layer on the photosensitive body become a major factor that influences a durability of a process cartridge, and because of a tendency to a high durability of the process cartridge, an improvement of durability is needed with respect to the occurrence of the film wear and the defect of the photosensitive body (for example, referring to Patent document 1).

Patent document 1: Japan patent publication of No. 2007˜25456

With respect to a problem of the durability of the process cartridge as stated above, usually, supposing that a film wear of the photosensitive layer occurs in the electrophotography process, a countermeasure is previously taken for making an initial thickness of the photosensitive layer thicker and for generating an over coat layer (inorganic photosensitive layer) such as a coating, an amorphous silicon and the like on the surface of the photosensitive layer in order to reduce a film wear amount.

However, the over coat layer is generated on the surface of the photosensitive layer, which becomes a primary factor of a cost up; and in the efficiency, there are some problems such that sensitivity of the photosensitive body becomes low. Further, in the case that the photosensitive body is a function separation layer type organic photosensitive body, the initial thickness of the photosensitive layer is preferred to be 10˜25 μm (more preferably, under 20 μm). Therefore, as for the high resolution, there is no possibility of making an initial thickness of the photosensitive layer thicker excessively.

### SUMMARY OF THE INVENTION

It is, therefore, an object of the invention to provide an image forming unit and an image forming apparatus that improve durability with respect to the film wear and the defect of the photosensitive layer on the photosensitive body and plan to thin a photosensitive layer in order to solve the above problem.

That is, a first aspect of the invention to provide an image forming unit, comprising: a photosensitive body; a charge means that charges surface of the photosensitive body; a development means that develops an electrostatic latent image formed on the surface of the photosensitive body with the developer through shining an exposure light to form a developer image on the surface of the photosensitive body; and a cleaning means that removes remaining developer on the surface of the photosensitive body by pressing against the surface of the photosensitive body, wherein on the top surface layer of the photosensitive body, Martens hardness value is 175˜196N/mm²; elastic deformation rate is 35˜48%; and static friction coefficient is under 0.535.

Further, a second aspect of the invention is to provide an image forming apparatus in which the image forming unit is comprised.

### THE EFFECT OF THE PRESENT INVENTION

According to the present invention, because the Martens hardness value of the top surface layer of the photosensitive body is regulated into 175˜196N/mm², the elastic deformation rate is regulated into 35˜48%, and the static friction coefficient is regulated under 0.535, the durability of the top surface layer is improved, and even though the initial thickness of the top surface layer is thinned, it is possible to realize a photosensitive body that has a good durability with respect to the film wear and the defect, thus, it is possible to provide an image forming unit and an image forming apparatus that materialize a high resolution and a high durability.

The above and other objects and features of the present invention will become apparent from the following detailed description and the appended claims with reference to the accompanying drawings.

### BRIEF DESCRIPTION OF THE DRAWINGS

FIG. 1 is a diagram showing an outline structure of an image forming apparatus of the present invention;

FIG. 2 is a diagram showing an outline structure of an image forming unit of the present invention;

FIG. 3 is a diagram showing a structure of a photosensitive body drum of the present invention;

FIG. 4 is a flow diagram showing a manufacturing process of the photosensitive body drum;

FIG. 5 is a diagram showing structure formulae of binder resins in charge transport layer application liquid;

FIG. 6 is a diagram showing a pressing status of a cleaning blade to a photosensitive body drum;

FIG. 7 is a diagram showing a print pattern for continuous print;

FIG. 8 is a diagram showing a print sample;

FIG. 9 is a diagram showing another print sample;

FIG. 10 is a diagram showing an evaluation result of continuous print in embodiment 1; and

FIG. 11 is a diagram showing an evaluation result of continuous print in embodiment 2.

### DETAILED DESCRIPTION OF THE PREFERRED EMBODIMENTS

Embodiments of the invention will be described in detail hereinbelow with reference to the drawings.

An image forming apparatus according to the present embodiment is a color printer that forms a toner image by making the toner adhere to an electrostatic latent image formed on the photosensitive body drum, transfers the toner image on a print medium; and obtains a print image to fix the transferred toner image through heat and pressure.

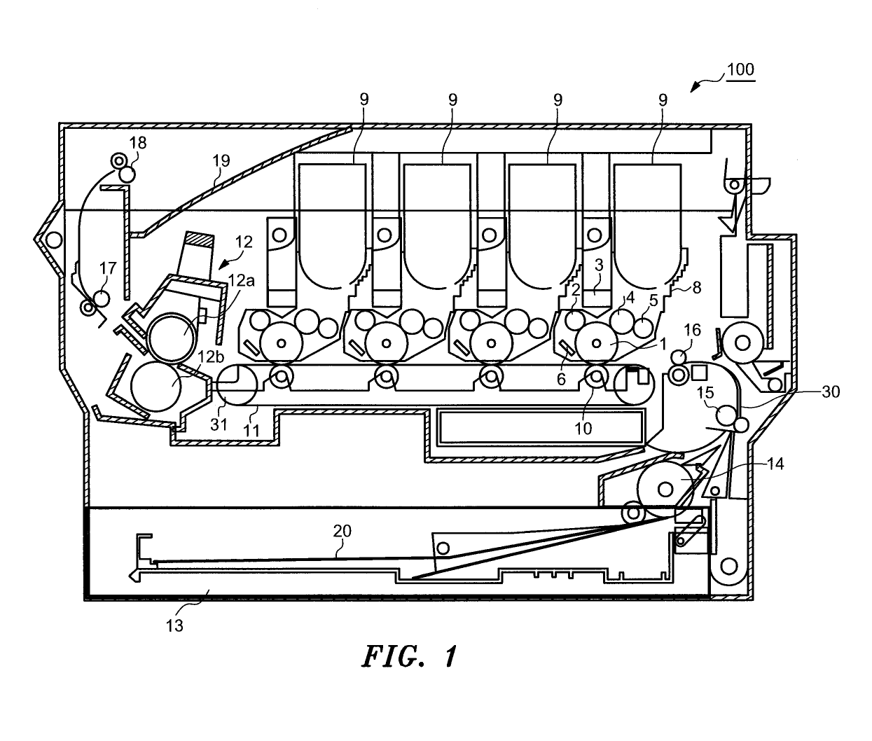

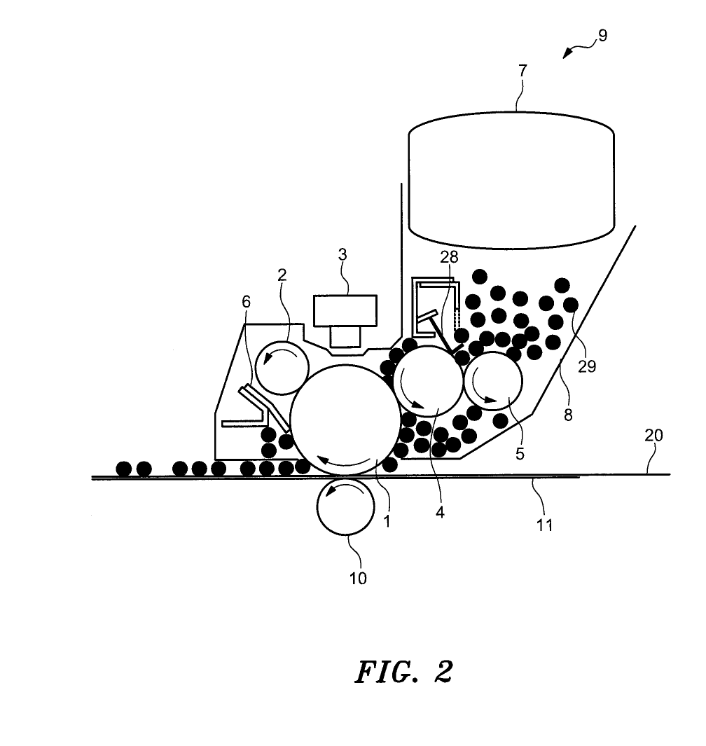

FIG. 1 is a diagram showing an outline structure of an image forming apparatus (color printer) of the present embodiment; and FIG. 2 is a diagram showing an outline structure of an image forming unit that is used in the image forming apparatus.

As shown by FIG. 1, a mark 100 represents an image forming apparatus, and a paper feeding cassette 13 that accommodates print media 20 is furnished on the bottom of the image forming apparatus 100. On the feeding side of the paper feeding cassette 13, a paper feeding roller 14 that feeds out the print media 20 accommodated in the paper feeding cassette 13 one by one; and on the downstream side, a conveyance roller 15, 16 that send out the print medium 20 fed out by the paper feeding roller 14 to an image forming unit 9 along a transport route 30.

The image forming unit 9, as shown by FIG. 2, includes a toner cartridge 7 and a drum cartridge 8 in which a toner 29 (for example, mono-component non-magnetism toner) is filled.

Further, in the drum cartridge 8, a photosensitive body drum 1 with a circular cylinder shape, a charge roller 2 that charges the surface of the photosensitive body drum 1, a development roller 4 that develops an electrostatic latent image formed on the surface of the photosensitive body drum 1 by exposing an exposure LED head 3 through the toner 29, a development blade 28 that regulates and unifies a thickness of a toner layer on the development roller 4, a sponge roller 5 to charge the toner 29 by stirring it, a cleaning blade 6 that presses against the surface of the photosensitive body drum 1 and cleans (removes) the toner 29 (remaining toner) remaining on the photosensitive body drum 1 after transfer, and the like are contained in unity.

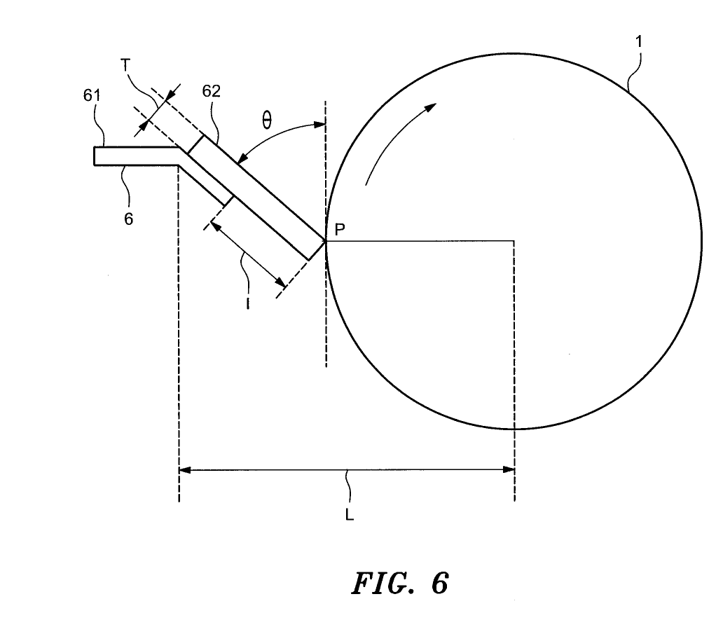

The cleaning blade 6, as shown by FIG. 6, is composed of a SUS made sheet metal support board 61 and a urethane rubber board 62 fixed on the SUS made sheet metal support board 61; the free end of the urethane rubber board 62 is furnished so as to press against the circumference surface of the photosensitive body drum 1 in a fixed pressing force.

Moreover, the pressing force is a force that is added in a perpendicular direction with respect to a tangent on the position (point P of FIG. 6) on which the tip of the free end touches with the photosensitive body drum 1.

Further, the exposure LED head 3 is furnished on the main body side of the image forming apparatus 100, and is capable of shining an exposure light on the surface of the contained photosensitive body drum 1.

Four of the image forming units 9 of the above-mentioned structure that forms toner images of respective colors with black (K), yellow (Y), magenta (M) and cyan (C) are furnished in an order from the upstream side of the transport route 30. Further, a transfer belt is inserted that is driven through a rotation of a drive roller 31, and then transfer rollers 10 are furnished corresponding to each photosensitive body drum 1 of the image forming units 9. In the case to transfer, in each transfer roller 10, a high voltage of opposite polarity to charge polarity of the toner image is added through a voltage generating section (not shown).

In the case that the print medium 20 conveyed through the transfer belt 11 passes the photosensitive body drum 1 of each image forming unit 9, in a touching section with the transfer roller 10, through a coulomb force that occurs because of the high voltage, the toner image formed on the photosensitive body drum 1 is transferred on the print medium 20 in each image forming unit 9 of respective colors.

At the downstream side of the image forming unit 9, a fixing apparatus 12 is furnished to fix the toner images of respective colors, those are transferred on the print medium 20 by the transfer rollers 10, through heat and pressure.

The fixing apparatus 12 includes a fixing roller 12a in which a fixed heat generation body (for example, halogen lamp; not shown) is equipped, and a pressure roller 12b that is pressed on the circumference surface of the fixing roller 12a through a pressure means (not sown).

Further, around the exit of the fixing apparatus 12, a conveyance roller 17, and at the downstream side, an ejection roller 18 are furnished; and the fixed print medium 20 that is sent out from the fixing apparatus 12 is ejected to an ejecting section 19 by passing the conveyance roller 17 and the ejection roller 18.

In the image forming apparatus 100 of the above-mentioned structure, in each image forming unit 9, through the exposure light of the exposure LED head 3 on the basis of an outside image signal, an electrostatic latent image is formed on the surface of the photosensitive body drum 1, is developed through the toner 29 of respective colors C, M, Y and K and an toner image is formed on the photosensitive body drum 1. The toner image is transferred to the print medium 20 that is conveyed from the paper feeding cassette 13 by passing the conveyance rollers 15, 16, the transfer belt 11 and the like through a transfer roller. At this time, after the toner image is transferred, remaining toner is removed through the cleaning blade 6.

The toner image transferred to the print medium 20, after being fixed on the print medium 20 through heat and pressure in the fixing apparatus 12, is ejected to the ejecting section 19 through the ejection roller 18.

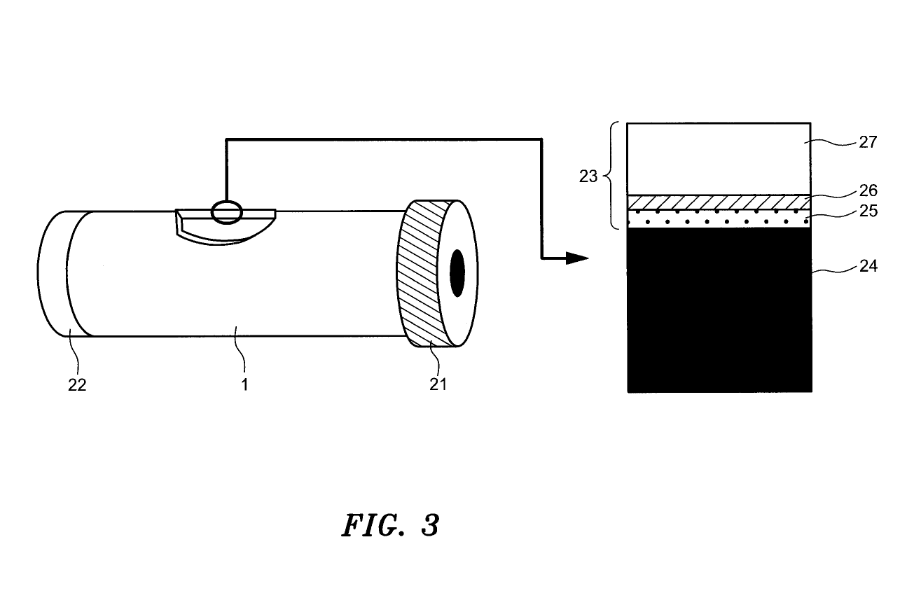

Next, on the basis of the FIG. 3, it is to explain about the photosensitive body drum 1 of the present embodiment. FIG. 3 is a diagram showing a structure of a photosensitive body drum 1.

As shown by FIG. 3, the photosensitive body drum 1 of the present embodiment includes a conductive support body 24 of a circular cylinder in which a photosensitive layer 23 is generated on the surface, a drum gear 21 and a drum flange 22 that are furnished on the both sides. A drive series (not shown) is connected to the drum gear 21, and in the time to print, the photosensitive body drum 1 is driven to rotate through the drive series.

The photosensitive layer 23 has a layered structure that is composed of a blocking layer 25, a charge generation layer 26 and a charge transport layer 27 of the top surface layer in the order from the surface of the conductive support body 24.

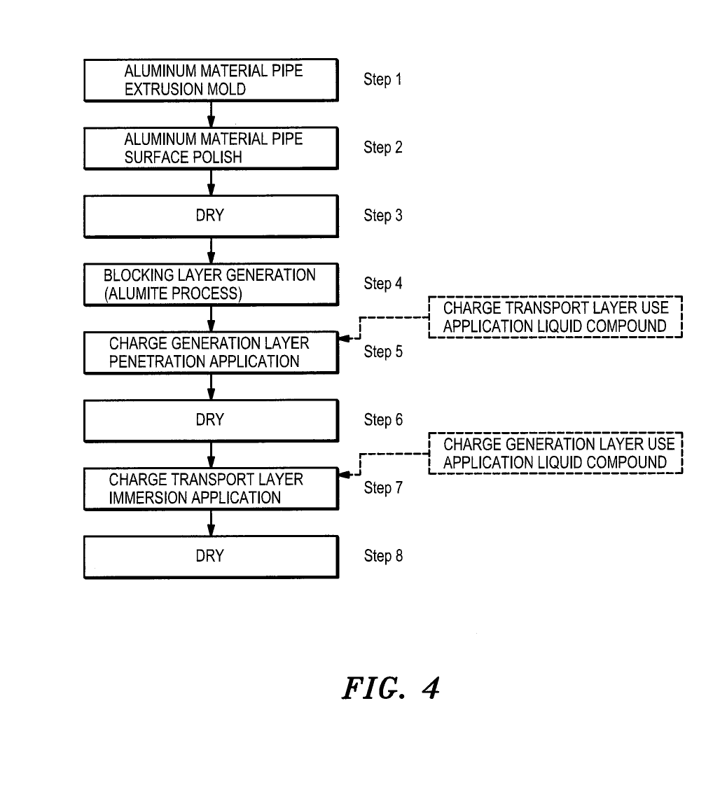

Next, on the basis of FIG. 4, it is to explain a manufacture method of the photosensitive body drum 1. FIG. 4 is a flow diagram showing a manufacturing process of the photosensitive body drum 1.

Firstly, in Step 1, as a material of the conductive support body 24, an aluminum alloy billet (in the present embodiment, an aluminum alloy of JIS-A3000 series that mixes silicon and the like into aluminum is used) is processed and mold in an extrusion pipe through a porthole method.

Next, in Step 2, it is to cut and process the extrusion pipe into a circular cylinder with fixed thickness and outside diameter. In the present embodiment, through the cutting and processing, surface polished conductive support body 24 (aluminum material pipe 24) with a 30 mm outside diameter, a 246 mm length and a 0.75 mm thickness is manufactured.

Next, in Step 3, the aluminum material pipe 24 that is manufactured in the former process is surface cleaned by putting it into a cleaning tank, and oil of the surface, different kinds of dust in the air and the like are removed, which are to dried.

Next, in Step 4, the blocking layer 25 is generated on the surface of the aluminum material pipe 24 that has been cleaned. In the present embodiment, after anodization (alumite) process is executed on the surface of the aluminum material pipe 24, a sealing process (sealing process of pore that is generated through the alumite process) that regards nickel acetate as a main ingredient is performed, and the blocking layer 25 is generated through a anodized coating (alumite layer) of about 6 μm.

Next, in Step 5, a charge generation layer 26 is generated on the blocking layer 25 that is generated in the former process. The charge generation layer 26 is generated through an immersion application method that applies by immersing the aluminum material pipe 24 in which the blocking layer 25 is generated in the liquid tank that is filled by the previously compounded charge generation layer use application liquid. In the present embodiment, the charge generation layer use application liquid is applied so that the charge generation layer 26 of about 0.3 μm is generated.

Further, it is to use a liquid as the charge generation layer use application liquid that has been adjusted and compounded so that a final solid content concentration becomes 4% and a mass rate of 1,2-dimethoxyethane and 4-methoxy-4-methylpentanone-2 becomes 9:1 by adding 10 parts (parts by mass) of oxyo-titanyl phthalocyanine to 150 parts of 1,2-dimethoxyethane and mixing 100 parts of a binder solution of slid content concentration 5% which dissolves 5 parts of polyvinyl butyral in 95 parts of 1,2-dimethoxyethane with 160 parts of a pigment dispersion liquid manufactured by a grinding dispersion process through a sand grind mill.

Next, in Step 6, by drying the aluminum material pipe 24 in which the charge generation layer 26 is applied on the blocking layer 25 to remove an extra solvent in the charge generation layer, the charge generation layer 26 is made to fix on the blocking layer 25.

Next, in Step 7, the charge transport layer 27 is generated on the charge generation layer 26. The charge transport layer 27 is generated through an immersion application method that applies by immersing the aluminum material pipe 24 in which the charge generation layer 26 is generated in the liquid tank that is filled by the previously compounded charge transport layer use application liquid. In the present embodiment, the charge transport layer use application liquid is applied so that the charge transport layer 27 of about 18 μm is generated.

Next, in Step 8, by drying the aluminum material pipe 24 in which the charge transport layer 27 is applied on the charge generation layer to remove an extra solvent in the charge transport layer, the charge transport layer 27 is made to fix on the charge generation layer 26.

Thus, the manufacture of the photosensitive body drum 1 shown by FIG. 3 is completed.

### Embodiment 1

In the charge transport layer immersion application process of Step 7, by using charge transport layer application liquid samples 1˜16 mentioned later, plural photosensitive body drums 1 are manufactured; and with respect to respective photosensitive body drum samples 1˜16, Martens hardness values, elastic deformation rates and static friction coefficients of top surface layer (namely, the charge transport layer 27) are measured.

The Martens hardness values and the elastic deformation rates are measured through using a microscopic hardness measurement apparatus and directly reading indentation depth in the time to continuously apply load to an indenter. In the present embodiment, a HM 2000 (made by Fischer company) is used as the microscopic hardness measurement apparatus to measure on the condition of a final load 10 mN.

Further, the static friction coefficient, as shown by FIG. 6, is calculated according to a pressing force value and a rotation torque value of the urethane rubber board 62 with respect to the photosensitive body drum 1 in the time to rotate the photosensitive drum 1 on the condition of touching the cleaning blade 6 with the circumference surface of the photosensitive body drum 1.

Moreover, regarding the urethane rubber board 62, thickness T is 2.1 mm, free end length l is 6.9 mm, hardness (Hs) is 74, Young's modulus is 70 kgf/cm², and impact resilience is 20%, abutment angle θ of the urethane rubber board 62 to the photosensitive body drum 1 is 11°, and jamming amount of the urethane rubber board to the photosensitive body drum 1 is 1.24 mm.

1-1 (Charge Transport Layer Application Liquid Sample 1)

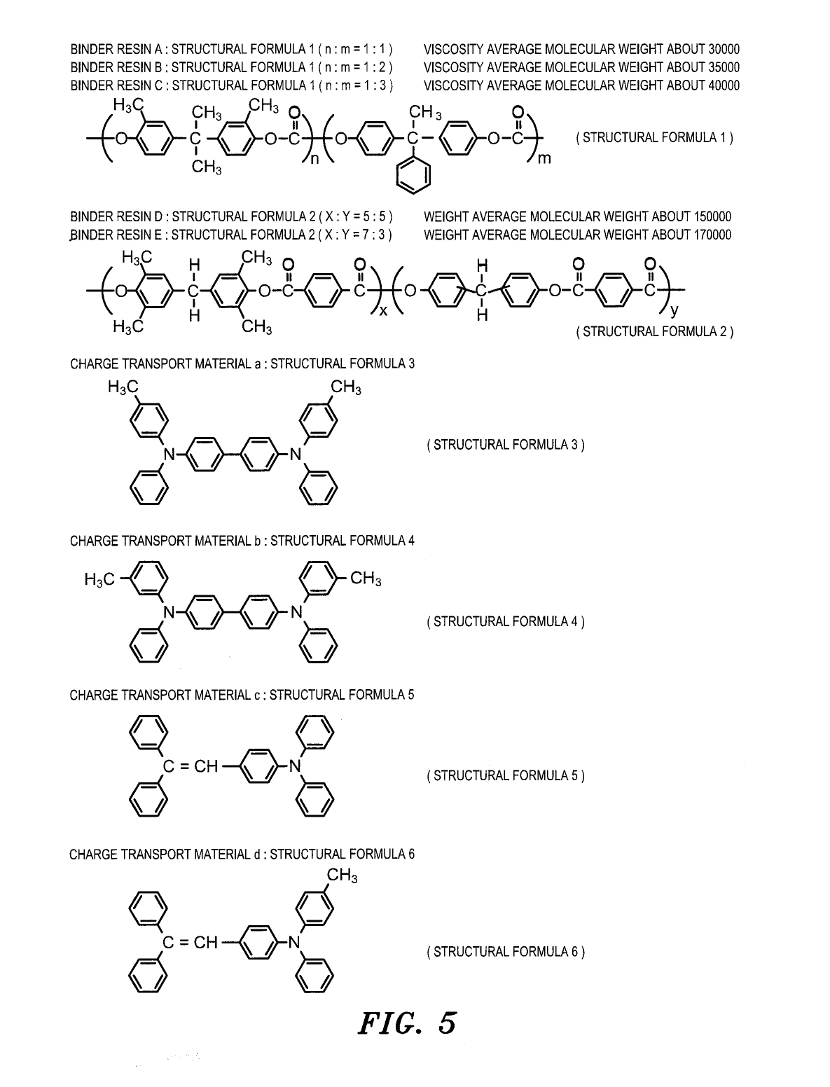

A liquid that dissolves 100 parts of a resin A as a binder resin and 45 parts of charge transport material c into a mixture solvent of tetrahydrofuran:toluene=80:20 is used as a charge transport layer use application liquid. The resin A is a material of a structural formula 1 of FIG. 5, and is a polycarbonate resin of n:m=1:1.

1-2 (charge transport layer application liquid sample 2)

A liquid that dissolves 100 parts of a resin A as a binder resin and 60 parts of charge transport material c into a mixture solvent of tetrahydrofuran:toluene=80:20 is regarded as a charge transport layer use application liquid. The resin A is a material of a structural formula 1, and is a polycarbonate resin of n:m=1:1, and the charge transport material a is a material of a structural formula 3.

1-3 (Charge Transport Layer Application Liquid Sample 3)

A liquid that dissolves 100 parts of a resin B as a binder resin and 45 parts of charge transport material c into a mixture solvent of tetrahydrofuran:toluene=80:20 is regarded as a charge transport layer use application liquid. The resin B is a material of a structural formula 1, and is a polycarbonate resin of n:m=1:2, and the charge transport material c is a material of a structural formula 5.

1-4 (Charge Transport Layer Application Liquid Sample 4)

A liquid that dissolves 100 parts of a resin B as a binder resin and 60 parts of charge transport material a into a mixture solvent of tetrahydrofuran:toluene=80:20 is regarded as a charge transport layer use application liquid. The resin B is a material of a structural formula 1, and is a polycarbonate resin of n:m=1:2, and the charge transport material a is a material of a structural formula 3.

1-5 (Charge Transport Layer Application Liquid Sample 5)

A liquid that dissolves 100 parts of a resin C as a binder resin and 45 parts of charge transport material c into a mixture solvent of tetrahydrofuran:toluene=80:20 is regarded as a charge transport layer use application liquid. The resin C is a material of a structural formula 1, and is a polycarbonate resin of n:m=1:3, and the charge transport material a is a material of a structural formula 3.

1-6 (charge transport layer application liquid sample 6)

A liquid that dissolves 100 parts of a resin C as a binder resin and 60 parts of charge transport material a into a mixture solvent of tetrahydrofuran:toluene=80:20 is regarded as a charge transport layer use application liquid. The resin C is a material of a structural formula 1, and is a polycarbonate resin of n:m=1:3, and the charge transport material a is a material of a structural formula 3.

1-7 (Charge Transport Layer Application Liquid Sample 7)

A liquid that dissolves 100 parts of a resin D as a binder resin and 45 parts of charge transport material a into a mixture solvent of tetrahydrofuran:toluene=80:20 is regarded as a charge transport layer use application liquid. The resin D is a material of a structural formula 2, and is a polyester resin of x:y=5:5, and the charge transport material c is a material of a structural formula 5.

1-8 (Charge Transport Layer Application Liquid Sample 8)

A liquid that dissolves 100 parts of a resin D as a binder resin and 60 parts of charge transport material a into a mixture solvent of tetrahydrofuran:toluene=80:20 is regarded as a charge transport layer use application liquid. The resin D is a material of a structural formula 2, and is a polyester resin of x:y=5:5, and the charge transport material a is a material of a structural formula 3.

1-9 (Charge Transport Layer Application Liquid Sample 9)

A liquid that dissolves 100 parts of a resin E as a binder resin and 45 parts of charge transport material c into a mixture solvent of tetrahydrofuran:toluene=80:20 is regarded as a charge transport layer use application liquid. The resin E is a material of a structural formula 2, and is a polyester resin of x:y=7:3, and the charge transport material c is a material of a structural formula 5.

1-10 (Charge Transport Layer Application Liquid Sample 10)

A liquid that dissolves 100 parts of a resin E as a binder resin and 60 parts of charge transport material a into a mixture solvent of tetrahydrofuran:toluene=80:20 is regarded as a charge transport layer use application liquid. The resin E is a material of a structural formula 2, and is a polyester resin of x:y=7:3, and the charge transport material a is a material of a structural formula 3.

1-11 (Charge Transport Layer Application Liquid Sample 11)

A liquid that dissolves 100 parts of a resin A as a binder resin and 35 parts of charge transport material b into a mixture solvent of tetrahydrofuran:toluene=80:20 is regarded as a charge transport layer use application liquid. The resin A is a material of a structural formula 1, and is a polycarbonate resin of n:m=1:1, and the charge transport material b is a material of a structural formula 4.

1-12 (charge transport layer application liquid sample 12)

A liquid that dissolves 100 parts of a resin D as a binder resin and 60 parts of charge transport material b into a mixture solvent of tetrahydrofuran:toluene=80:20 is regarded as a charge transport layer use application liquid. The resin D is a material of a structural formula 2, and is a polyester resin of x:y=5:5, and the charge transport material b is a material of a structural formula 4.

1-13 (charge transport layer application liquid sample 13)

A liquid that dissolves 100 parts of a resin D as a binder resin and 35 parts of charge transport material c into a mixture solvent of tetrahydrofuran:toluene=80:20 is regarded as a charge transport layer use application liquid. The resin D is a material of a structural formula 2, and is a polyester resin of x:y=5:5, and the charge transport material c is a material of a structural formula 3.

1-14 (Charge Transport Layer Application Liquid Sample 14)

A liquid that dissolves 100 parts of a resin E as a binder resin and 60 parts of charge transport material c into a mixture solvent of tetrahydrofuran:toluene=80:20 is regarded as a charge transport layer use application liquid. The resin E is a material of a structural formula 2, and is a polyester resin of x:y=7:3, and the charge transport material c is a material of a structural formula 5.

1-15 (Charge Transport Layer Application Liquid Sample 15)

A liquid that dissolves 100 parts of a resin D as a binder resin and 35 parts of charge transport material d into a mixture solvent of tetrahydrofuran:toluene=80:20 is regarded as a charge transport layer use application liquid. The resin D is a material of a structural formula 2, and is a polyester resin of x:y=5:5, and the charge transport material d is a material of a structural formula 6.

1-16 (Charge Transport Layer Application Liquid Sample 16)

A liquid that dissolves 100 parts of a resin C as a binder resin and 35 parts of charge transport material d into a mixture solvent of tetrahydrofuran:toluene=80:20 is regarded as a charge transport layer use application liquid. The resin C is a material of a structural formula 1, and is a polycarbonate resin of n:m=1:3, and the charge transport material d is a material of a structural formula 6.

Here, as the binder resin A˜E, resin whose viscosity average molecular weight is over 30000, or whose weight average molecular weight is over 150000 is used.

With regard to the photosensitive body drum samples 1˜16 that are manufactured by using the charge transport layer application liquid samples 1˜16, an evaluation of continuous print according to the following conditions (1)˜(3) has been performed by using the image forming apparatus 100 shown by FIG. 1.

(1) By using print media with A4 size and a print pattern for continuous print, 10000 sheets per day, 40000 sheets in total are continuously printed for four days.

Moreover, the print pattern, as shown by FIG. 7, prints lateral pattern that is composed of respective colors of K, Y, M and C in 3%. The print of 3% solidly prints 3% of an area in a print medium with respective colors.

(2) In the case of continuous print, at the beginning of the print and every 200000 sheets, the following two kinds of print samples are printed and picked, and the image qualities of these print samples are evaluated in visual.

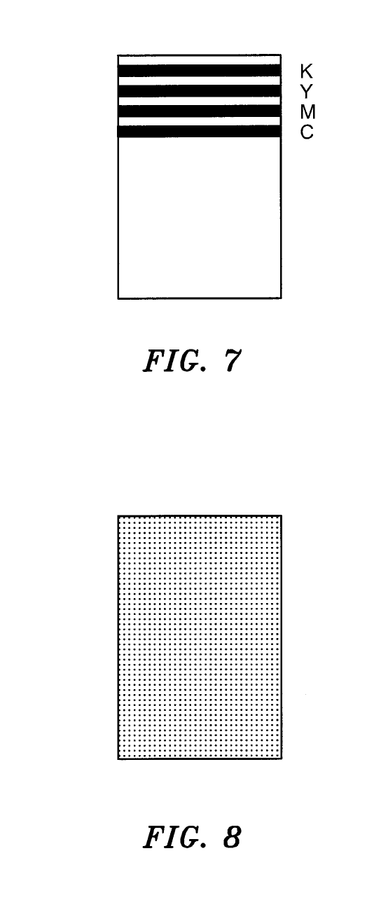

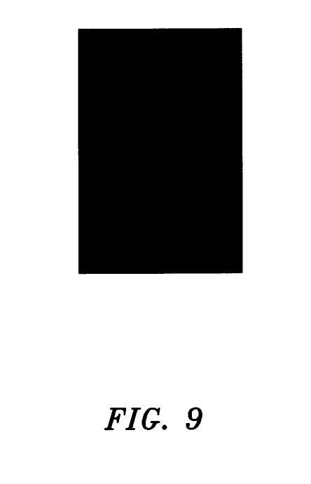

Moreover, the print sample is a half-tone print of 25% according to respective colors of K, Y, M and C as shown by FIG. 8, and is a solid print of the whole print medium as shown by FIG. 9. The half-tone print of 25% performs a print of one dot every one dot in the whole print medium.

(3) After the continuous print is completed, by taking out the photosensitive body drum 1 from the image forming unit and measuring film thickness of photosensitive layer, film wear amount from the initial thickness (18 μm) of the charge transport layer 27 is investigated.

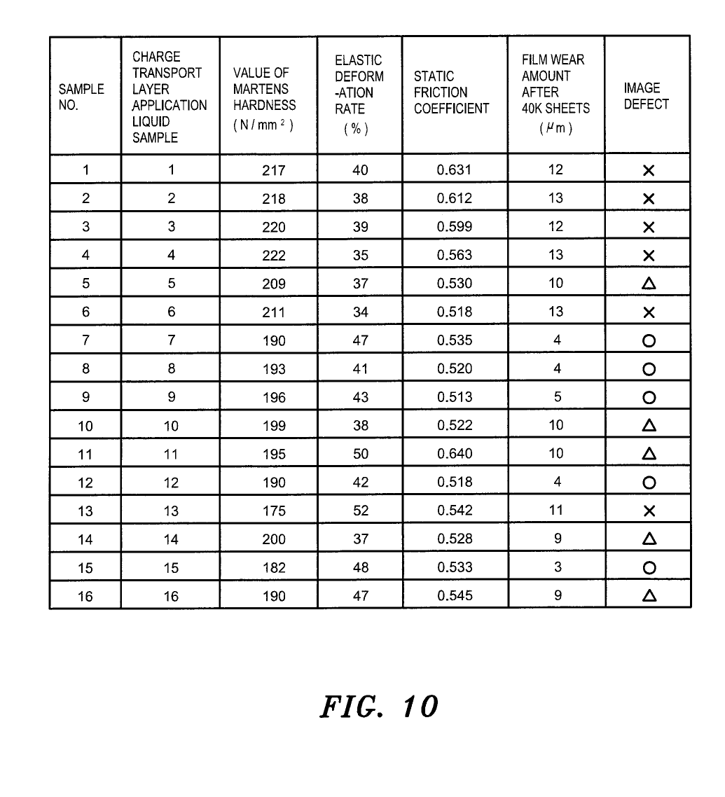

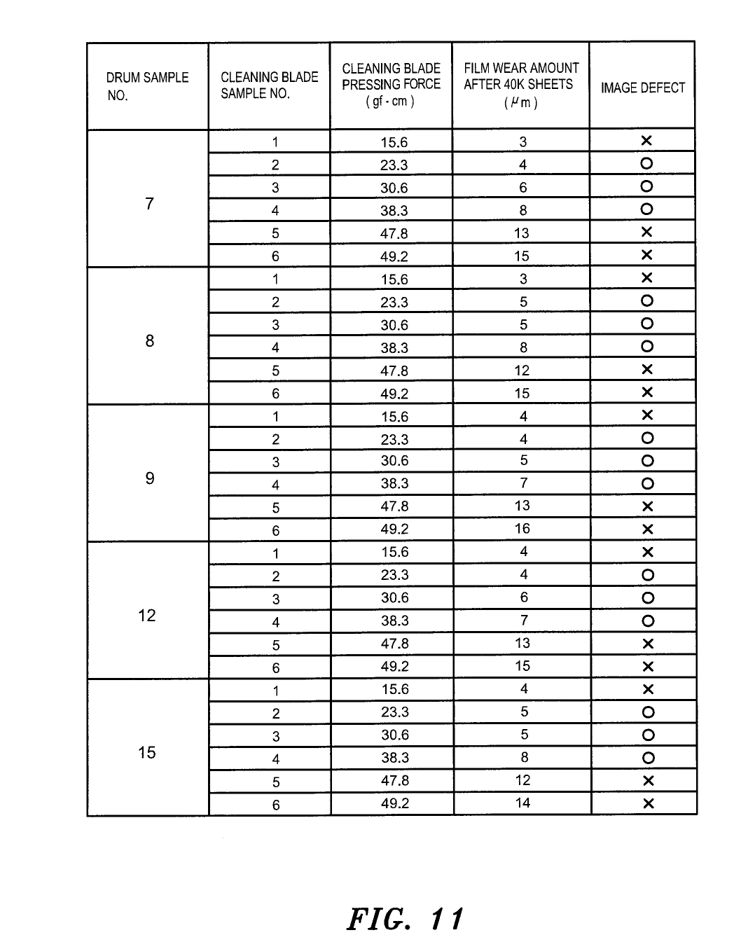

FIG. 10 is a diagram showing an evaluation result of continuous print in embodiment 1. Moreover, the evaluation of the image quality is regarded as “◯” when image defect cannot be confirmed, is regarded as “X” when image defect can be confirmed, and is regarded as “Δ” when image defect is slight but is not permitted.

According to FIG. 10, as samples No. 7˜9, 12 and 15, when the Martens hardness value is under 196N/mm², the elastic deformation rate is under 48%, and the static friction coefficient is under 0.535, the film wear amount of the photosensitive layer (the charge transport layer 27) after the continuous print is 3˜5 μm which is extremely low, and the image quality is also good.

However, as sample No. 16, even though the Martens hardness value is under 196N/mm², and the elastic deformation rate is under 48%, when the static friction coefficient is big, there is also much film wear amount of the photosensitive layer, and image defect (Δ) such as unevenness of density is confirmed.

Further, as samples No. 5, 10 and 14, even though the elastic deformation rate is under 48%, and the static friction coefficient is under 0.535, when the Martens hardness is big, there is also much film wear amount of the photosensitive layer, serious defect occurs on the photosensitive body drum 1, and image defect (A) is confirmed.

Furthermore, as sample No. 11, even though the Martens hardness is under 196N/mm², when the elastic deformation rate and the static friction coefficient are big, there is also much film wear amount of the photosensitive layer, small defect occurs on the photosensitive body drum 1, and image defect (A) is confirmed.

According to the above result, through regulating the Martens hardness value of the charge transport layer 27 of the photosensitive body drum into 175˜196N/mm², the elastic deformation rate into 35˜48%, and the static friction coefficient under 0.535, even when the initial film thickness of the charge transport layer 27 is thinned as 15 μm, and even though the biggest film wear amount of 5 μm occurs, it becomes obvious that it is possible to guarantee a lower limit value 10 μm of desirable initial film.

Further, as a binder resin for the charge transport layer 27, it becomes obvious that the one using polyester resin is better than the one using polycarbonate resin in durability.

As mentioned above, according to the embodiment 1, through regulating the Martens hardness value of the top surface layer (the charge transport layer 27) of the photosensitive body drum into 175˜196N/mm², the elastic deformation rate into 35˜48%, and the static friction coefficient under 0.535, the durability is improved with respect to the film wear and the defect of the charge transport layer 27. Therefore, it becomes possible to thin the photosensitive layer film thickness (for example, 15 μm) corresponding to a recent demand for high resolution, and it is possible to realize an image forming unit and an image forming apparatus that materialize a high resolution and a high durability. It is desirable to regulate the Martens hardness value of the top surface layer (charge transport layer 27) of the photosensitive body into 182˜196N/mm², the elastic deformation rate into 41˜48% and the static friction coefficient into 0.513˜0.535.

### Embodiment 2

As stated above, the cleaning blade 6 is furnished so that the tip part presses against the surface of the photosensitive body drum 1, and has a structure for scratching down the remaining toner on the photosensitive body drum 1 through the friction. However, when the pressing force against the photosensitive body drum 1 is too small, the image defect caused by poor cleaning of the remaining toner and drum filming (a phenomenon that the toner adheres on the photosensitive body drum 1) is easy to happen. On the contrary, when the pressing force is too big, the film wear amount of the photosensitive layer (the charge transport layer 27) is increased, and it becomes a cause that makes the durability of the unit shorter; and when pressure impression occurs on the surface of the photosensitive body drum 1, it will cause a fall of the image quality.

In the embodiment 2, for investigating the influence of the pressing force of the cleaning blade 6 against the photosensitive body drum 1, with regard to the cleaning blade 6 of FIG. 6, by using an urethane rubber board whose hardness (Hs) is 74, whose Young's modulus is 70 kgf/cm² and whose impact resilience is 20%, and by regarding the abutment angle θ to the photosensitive body drum 1 as 11°, cleaning blade samples 1˜6 are manufactured through the following rubber board thickness T, free end length l and pressing force.

Moreover, in FIG. 6, because the distance L between the cleaning blade 6 and the center of the photosensitive body drum 1 is constant, according to the thickness T (mm) of the urethane rubber board 62 and the free end length l (mm) of the urethane rubber board 62, the abutment angle θ of the urethane rubber board 62 to the photosensitive body drum 1 and the pressing force [gf·cm] of the urethane rubber board 62 at the touch point P is uniquely decided.

2-1 (Cleaning Blade Sample 1)

rubber board thickness: 1.7 mm, free end length: 7.5 mm (pressing force: 15.6 gf·cm)

2-2 (Cleaning Blade Sample 2)

rubber board thickness: 1.8 mm, free end length: 7.7 mm (pressing force: 23.3 gf·cm)

2-3 (Cleaning Blade Sample 3)

rubber board thickness: 1.9 mm, free end length: 7.5 mm (pressing force: 30.6 gf·cm)

2-4 (Cleaning Blade Sample 4)

rubber board thickness 2.0 mm, free end length 7.7 mm (pressing force: 38.3 gf·cm)

2-5 (Cleaning Blade Sample 5)

rubber board thickness 2.1 mm, free end length 7.7 mm (pressing force: 47.8 gf·cm)

2-6 (Cleaning Blade Sample 6)

rubber board thickness 2.1 mm, free end length 7.5 mm (pressing force: 49.2 gf·cm)

With respect to the cleaning blade samples 1˜6, among the photosensitive body drum samples in the embodiment 1, by using five kinds of the photosensitive body drums (drum samples No. 7, 8, 9, 12 and 15) in which the image defect cannot be confirmed, an evaluation of continuous print is executed according to the same conditions (1)˜(3) as those in the embodiment 1.

FIG. 11 is a diagram showing an evaluation result of continuous print in embodiment 2. The evaluation of the image quality, the same as the embodiment 1, is regarded as “◯” when image defect cannot be confirmed, is regarded as “X” when image defect can be confirmed, and is regarded as “Δ” when image defect is slight but is not permitted.

According to FIG. 11, as the cleaning blade sample 1, when the pressing force of the cleaning blade is 15.6 gf·cm that is small, though the film wear amount of the photosensitive layer is small in the case of continuous print of 40000 sheets, the image defect occurs because of slip and filming of the toner during the continuous print, and a high image quality cannot be kept.

Further, as the cleaning blade samples 2˜4, when the pressing force of the cleaning blade is 23.3˜38.3 gf·cm, the image defect cannot be confirmed during continuous print of 40000 sheets, and a high image quality can be kept.

Furthermore, as the cleaning blade samples 5 and 6, when the pressing force of the cleaning blade is over 47.83 gf·cm that is big, there is much film wear amount of the photosensitive layer during continuous print of 40000 sheets, which caused the image defect that is confirmed, and a high image quality cannot be kept.

Moreover, the above result has the same tendency as to the whole of the drum samples 7, 8, 9, 12 and 15.

According to the result mentioned above, with respect to the photosensitive body drum of the embodiment 1 that regards the Martens hardness value of the top surface layer (the charge transport layer 27) as 175˜196N/mm², the elastic deformation rate as 35˜48%, and the static friction coefficient as under 0.535, furthermore, by setting the pressing force of the cleaning blade 6 within the region of 23.3˜38.3 gf·cm, it becomes obvious that it is effective with respect to the improvement of the durability of the photosensitive layer.

As stated above, according to the embodiment 2, through regulating the Martens hardness value of the first surface layer (the charge transport layer 27) of the photosensitive body drum into 175˜196N/mm², the elastic deformation rate into 35˜48%, and the static friction coefficient under 0.535, furthermore, through regulating the pressing force of the cleaning blade 6 into the region of 23.3˜38.3 gf·cm, it is possible to realize an image forming unit and an image forming apparatus that improves the durability more than that of the embodiment 1.

### THE UTILIZATION POSSIBILITY IN INDUSTRY

In the present embodiment, it is to explain about a printer, but it can also apply to an image forming apparatus such as a copying machine, a facsimile, or a MFP (Multiple Function Peripheral) to compound functions of theses apparatuses and the like in electrophotographic system.

The present invention is not limited to the foregoing embodiments but many modifications and variations are possible within the spirit and scope of the appended claims of the invention.

What is claimed is:

1. An image forming unit, comprising:
a photosensitive body;
a charge means that charges surface of the photosensitive body;
a development means that develops an electrostatic latent image formed on the surface of the photosensitive body with the developer through shining an exposure light to form a developer image on the surface of the photosensitive body; and
a cleaning means that removes remaining developer on the surface of the photosensitive body by pressing against the surface of the photosensitive body,
wherein on the top surface layer of the photosensitive body,
Martens hardness value is 175˜196N/mm²;
elastic deformation rate is 35˜48%; and
static friction coefficient is under 0.535.

2. The image forming unit according to claim 1,
wherein binder resin used for the top surface layer of the photosensitive body is polyester resin.

3. The image forming unit according to claim 2,
wherein the cleaning means is an elasticity rubber blade; and the pressing force of the elasticity rubber blade against the surface of the photosensitive body is 23.3˜38.3 gf·cm.

4. An image forming apparatus which copmprises an image forming unit, comprising:
a photosensitive body;
a charge means that charges surface of the photosensitive body;
a development means that develops an electrostatic latent image formed on the surface of the photosensitive body with the developer through shining an exposure light to form a developer image on the surface of the photosensitive body; and
a cleaning means that removes remaining developer on the surface of the photosensitive body by pressing against the surface of the photosensitive body,
wherein on the top surface layer of the photosensitive body,
Martens hardness value is 175˜196N/mm²;
elastic deformation rate is 35˜48%; and
static friction coefficient is under 0.535.

5. The image forming apparatus according to claim 4,
wherein binder resin used for the top surface layer of the photosensitive body is polyester resin.

6. The image forming apparatus according to claim 5,
wherein the cleaning means is an elasticity rubber blade; and the pressing force of the elasticity rubber blade against the surface of the photosensitive body is 23.3˜38.3 gf·cm.

7. An image forming unit, comprising:
a photosensitive body;
a charge means that charges surface of the photosensitive body;
a development means that develops an electrostatic latent image formed on the surface of the photosensitive body with the developer through shining an exposure light to form a developer image on the surface of the photosensitive body; and
a cleaning means that removes remaining developer on the surface of the photosensitive body by pressing against the surface of the photosensitive body,
wherein on the top surface layer of the photosensitive body,
Martens hardness value is under 196N/mm²;
elastic deformation rate is under 48%; and
static friction coefficient is under 0.535.

8. The image forming unit according to claim 7,
wherein the static friction coefficient is 0.513˜0.535.

9. The image forming unit according to claim 7,
wherein the elastic deformation rate is 41˜48%; and
the static friction coefficient is 0.513˜0.535.

10. The image forming unit according to claim 7,
wherein the Martens hardness value is 182˜196N/mm²;
the elastic deformation rate is 41˜48%; and
the static friction coefficient is 0.513˜0.535.

11. The image forming unit according to claim 7,
wherein binder resin used for the top surface layer of the photosensitive body is polyester resin.

12. The image forming unit according to claim 7,
wherein the cleaning means is an elasticity rubber blade; and the pressing force of the elasticity rubber blade against the surface of the photosensitive body is 23.3˜38.3 gf·cm.

13. An image forming apparatus which comprises an image forming unit, comprising:
a photosensitive body;
a charge means that charges surface of the photosensitive body;
a development means that develops an electrostatic latent image formed on the surface of the photosensitive body with the developer through shining an exposure light to form a developer image on the surface of the photosensitive body; and
a cleaning means that removes remaining developer on the surface of the photosensitive body by pressing against the surface of the photosensitive body,
wherein on the top surface layer of the photosensitive body,
Martens hardness value is under 196N/mm²;
elastic deformation rate is under 48%; and
static friction coefficient is under 0.535.

14. The image forming unit according to claim 13,
wherein the static friction coefficient is 0.513˜0.535.

15. The image forming unit according to claim 13,
wherein the elastic deformation rate is 41˜48%; and
the static friction coefficient is 0.513˜0.535.

16. The image forming unit according to claim 13,
wherein the Martens hardness value is 182˜196N/mm²;
the elastic deformation rate is 41˜48%; and
the static friction coefficient is 0.513˜0.535.

17. The image forming unit according to claim 13,
wherein binder resin used for the top surface layer of the photosensitive body is polyester resin.

18. The image forming unit according to claim 13,
wherein the cleaning means is an elasticity rubber blade; and the pressing force of the elasticity rubber blade against the surface of the photosensitive body is 23.3˜38.3 gf·cm.
